(19) United States
(12) Patent Application Publication
(10) Pub. No.: US 2024/0245569 A1
(43) Pub. Date: Jul. 25, 2024

(54) FRONT-LEG ASSISTIVE EXOSKELETON

(71) Applicant: California Institute of Technology, Pasadena, CA (US)

(72) Inventors: Lorenzo Franceschini Shaikewitz, Durham, NC (US); Maegan Tucker, Atlanta, GA (US); Neil C. Janwani, Midland, MI (US); Aaron D. Ames, Pasadena, CA (US)

(73) Assignee: California Institute of Technology, Pasadena, CA (US)

(21) Appl. No.: 18/422,871

(22) Filed: Jan. 25, 2024

Related U.S. Application Data
(60) Provisional application No. 63/440,965, filed on Jan. 25, 2023.

(51) Int. Cl. A61H 3/00; B25J 9/00

(52) U.S. Cl. CPC A61H 3/00; B25J 9/0006; A61H 2003/007; A61H 2205/106

(57) ABSTRACT

A front-leg assistive exoskeleton provides the ability to augment a human gait. A shin mount comprising a material secures to a shin of a person such that the shin mount is enabled to push and pull on the shin in a normal direction. A foot mount attaches to a top of a shoe. A connector connects the shin mount to the foot mount. The connector houses an actuator that applies forces that generates torque about an ankle that modifies a gait of the person.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 63/440,965, filed on Jan. 25, 2023, with inventor(s) Lorenzo Shaikewitz, Maegan Tucker, Neil Janwani, and Aaron D Ames, entitled “Front-Leg Assistive Exoskeleton,” attorneys' docket number 176.0225USP1.

### BACKGROUND OF THE INVENTION

### 1. Field of the Invention

The present invention relates generally to powered exoskeletons, and in particular, to a method, apparatus, and system for a front-leg assistive ankle exoskeleton.

### 2. Description of the Related Art

(Note: This application references a number of different publications as indicated throughout the specification by names and years enclosed in brackets, e.g., [Smit et al. 2016]. A list of these different publications ordered according to these references can be found below in the section entitled “References.” Each of these publications is incorporated by reference herein.)

Powered exoskeletons provide a promising means to increase the limits of human activity and aid with rehabilitation for locomotive impairments. Existing ankle exoskeletons are capable of producing significant torques and, under the right conditions, reducing muscle activity by more than 10% [Mooney et. al. 2014]. These powerful machines can operate for hours without a tether and utilize sophisticated control systems to maximize effectiveness. The major remaining barrier in exoskeleton design is versatility: large, rigid ankle exoskeletons are clumsy augmentations to a refined human body; their designs and control may provide significant benefit in one gait, but cannot adapt to the many gaits used in everyday life [Galle et. al. 2017].

Furthermore, no ankle exoskeleton platform has been widely adopted in clinical settings, or even for testing controls in the research setting. Existing designs vary significantly and are often highly specialized. Exoskeletons mounted to the back of the lower-leg, such as those actuated with pneumatics [Gordon et. al. 2007] or completely passive [Collins et. al. 2015], require heavily customized shoes and rigid calf mounts that significantly limit the efficacy of their design. Alternatively, exoskeletons mounted to the sides of the lower-leg, including a strut-based design [Mooney et. al. 2014], suffer from incorporation of dangerous, fast moving moment arms that significantly limit their range of possible gaits. Even other exoskeletons mounted to the front of the lower-leg (which we term front-leg ankle exoskeletons) suffer from the same issues (see [Ferris et. al. 2006]): they are bulky and highly customized to the individual user.

To better understand the problems/limitations summarized above, a more detailed description of the problems and solutions of the prior art follows.

Powered robotic exoskeletons have enormous potential to enhance human capabilities. Among the range of human functions, improving locomotion is of particular interest because of its ubiquity and importance in daily life. The average adult spends nearly 90 minutes of each day walking [Johansson et al., 2019]. For some, locomotion and heavy lifting is an essential part of their occupation. Others who struggle with normal walking face many barriers navigating our world. Devices that reduce the energy cost of walking could make strenuous occupations easier and increase the quality of life for those who struggle with locomotion.

Ankle exoskeletons are a class of lower-limb exoskeletons that provide assistive forces to the ankle joint. By exerting an additional torque about the ankle, these devices have been shown to reduce the metabolic expenditure of non-disabled individuals across a range of walking speeds [Zhang et al., 2017; Mooney et. al. 2014; Slade et al., 2022]. Furthermore, this supplementary torque has been shown to have additional mechanical advantages for individuals with locomotive impairments, such as improved gait symmetry for persons post-stroke [Takahashi et. al. 2015].

### Previous Ankle Exoskeletons

The last two decades of research have seen enormous improvements in exoskeleton design and capabilities. The first prominent class of ankle exoskeletons was powered by pneumatic actuators. [Ferris et al., 2006] developed an ankle exoskeleton that aligned pneumatics with key muscles, reducing soleus electromyography (EMG) root-mean-square by 65% during level-ground walking. Pneumatic force was applied as a function of lower-limb EMG signals, a method known as proportional myoelectric control. This development inspired a wave of other pneumatic ankle exoskeletons that used different control methods including footswitch-based timing [Galle et al., 2013], EMG signals [Takahashi et. al. 2015], and optimization of metabolic cost [Galle et al., 2017].

Early pneumatic ankle exoskeletons established several key results on user adaptation to exoskeleton assistance. [Kao et. al. 2010] showed that exoskeleton assistance during walking can modify human gait kinematics, but humans tend to return to their original joint moments as they get comfortable with the exoskeleton. [Galle et al., 2013] confirmed these results, showing how an adaptation period can improve metabolic reduction from 9% to 16% compared to walking with an unpowered device. This result was achieved with actuation at a fixed percentage of the user's gait, as determined by a footswitch; although this simple control achieved large muscle activity reduction, the adaptation period suggests its limitations. Under this control scheme, the exoskeleton forces its user to adapt to assistance, rather than providing optimal assistance that adapts to the user.

While useful in the laboratory, pneumatic ankle exoskeletons require large air compressors that make them impractical for daily use. Further, they need heavy, customized attachments to mount to the body. [Mooney et. al. 2014] presented a viable alternative to pneumatics with their untethered strut-based ankle exoskeleton. It used large cable-driven moment arms to generate an ankle torque without attempting to directly imitate a muscle, achieving an 11% reduction in the metabolic cost of walking under loaded conditions [Mooney et. al. 2016]. The exoskeleton specifically targeted plantar flexion, demonstrating that push-off assistance can reduce metabolic cost of walking even under loaded conditions.

The use of metabolics to evaluate the effectiveness of ankle exoskeletons has become the de facto standard (Samuel Galle et al., 2017), providing a single number that captures the total energy cost of motion with and without exoskeleton assistance. The key metric for exoskeleton success is reducing metabolic cost compared to unpowered or normal walking. While useful for non-disabled individuals, it is important to remember that this number does not capture the complex effects of using an ankle exoskeleton including adaptation time, gait kinematics, or walking speed.

In recent years, many other ankle exoskeletons have been developed with increasingly large metabolic cost reductions. One prominent design replaces the struts used by [Mooney et. a. 2014] with cables directly connected to the back of the foot to target push-off [Zhang et al., 2017]. Using a human-in-the-loop optimization technique paired with a parameterized control curve, this design has achieved metabolic cost reductions of 24%. The addition of data-driven methods brought these results out of the laboratory setting, achieving 17% energy reduction compared to normal shoes and a consistently faster walking speed [Slade et al., 2022].

These designs generally offer large mechanical power, leaving it to a control system to determine how best to apply the substantial available ankle torque. However, this is not the only approach. [Collins et. al. 2015] designed a completely passive ankle exoskeleton that takes advantage of observed Achilles tendon dynamics. It used a spring-clutch mechanism attached to the back of the leg to selectively apply assistive forces, reducing metabolic cost of transport by 7% without any external power input [Collins et. al. 2015]. This highlights the interplay between design and control; powerful exoskeletons can create substantial improvement with large torques and careful control, but well designed exoskeletons can reduce energy cost with fixed control and no applied torque.

These designs were a major breakthrough in ankle exoskeleton development, promising impressive assistance without the need for nearby machinery. However, their use is heavily limited. [Slade et al 2022]'s cable-driven exoskeleton is a large, heavy machine with fast-moving cables and spools that require heavily customized shoes to function. Further, it is not clear how to generalize cable-driven exoskeletons to provide assistance to those with injury, muscle weakness, or gait asymmetries. The Collins passive design is lightweight, but has no capacity to adjust its control to different gaits [Collins et. al. 2015]. There is no intermediate, untethered ankle exoskeleton that combines the generalizability enabled by actuation with a lightweight and safe design.

Advancements in compact and flexible actuators enable a transition away from heavy, rigid exoskeletons without sacrificing actuation. Embodiments of the invention present an ankle exoskeleton that uses recently developed handed shearing axuetics to generate linear motion. These soft materials enable a lightweight, compliant design with inherent, controllable spring-like dynamics. Although the strength of actuation is limited by the current state of these materials, results demonstrate that even weak soft actuators can provide meaningful assistance during walking.

### SUMMARY OF THE INVENTION

Embodiments of the invention provide a front-leg ankle exoskeleton that provides a versatile augmentation to the human body with strong potential in research and medical applications. Novelty may include the ability to provide secure, comfortable attachment points at the shin and the top of the foot without the need for custom-molded parts. Between these attachment points, a pair of telescoping tubes enables the addition of passive or active actuation. Both attachment points have inertial measurement units (IMUs) built in to provide real-time estimation of forces and angles, allowing the device to perform sophisticated control and analysis of a gait.

### BRIEF DESCRIPTION OF THE DRAWINGS

Referring now to the drawings in which like reference numbers represent corresponding parts throughout:

FIG. 1 illustrates two exemplary configurations of a front-leg ankle exoskeleton attached to a body in accordance with one or more embodiments of the invention;

FIG. 2 illustrates an example control scheme for a front-leg ankle exoskeleton in accordance with one or more embodiments of the invention;

FIG. 3 illustrates an image and close-up of a shoe attachment piece in accordance with one or more embodiments of the invention;

FIG. 4 illustrates a custom shin attachment/shin mount as part of a full ankle exoskeleton and hidden components in accordance with one or more embodiments of the invention;

FIGS. 5A-5D illustrate variations of the front-leg ankle exoskeleton based on applications in accordance with one or more embodiments of the invention;

FIG. 6A illustrates the subcomponents of an HSA-spring design and FIG. 6B illustrates an exploded view of a motor assembly in accordance with one or more embodiments of the invention;

FIG. 7 illustrates a full design of an exemplary exoskeleton in accordance with one or more embodiments of the invention;

FIG. 8 shows qualitatively how ankle power peaks during the push-off period in accordance with one or more embodiments of the invention;

FIG. 9 illustrates a comparison of designs in accordance with one or more embodiments of the invention;

FIG. 10 illustrates a passive extension-spring ankle exoskeleton in accordance with one or more embodiments of the invention;

FIG. 11 illustrates a drone motor design in accordance with one or more embodiments of the invention;

FIG. 12 illustrates a worm gearbox design in accordance with one or more embodiments of the invention;

FIG. 13 illustrates true HSA displacement and spring constant values in accordance with one or more embodiments of the invention;

FIG. 14 illustrates a bang-bang control paradigm to generate assistive torques in accordance with one or more embodiments of the invention;

FIG. 15 shows the placement of EMG sensors in accordance with one or more embodiments of the invention;

FIG. 16 illustrates EMG results based on test data in accordance with one or more embodiments of the invention;

FIG. 17 illustrates the metabolic cost results in accordance with one or more embodiments of the invention; and

FIG. 18 illustrates the logical flow for augmenting a human gait in accordance with one or more embodiments of the invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

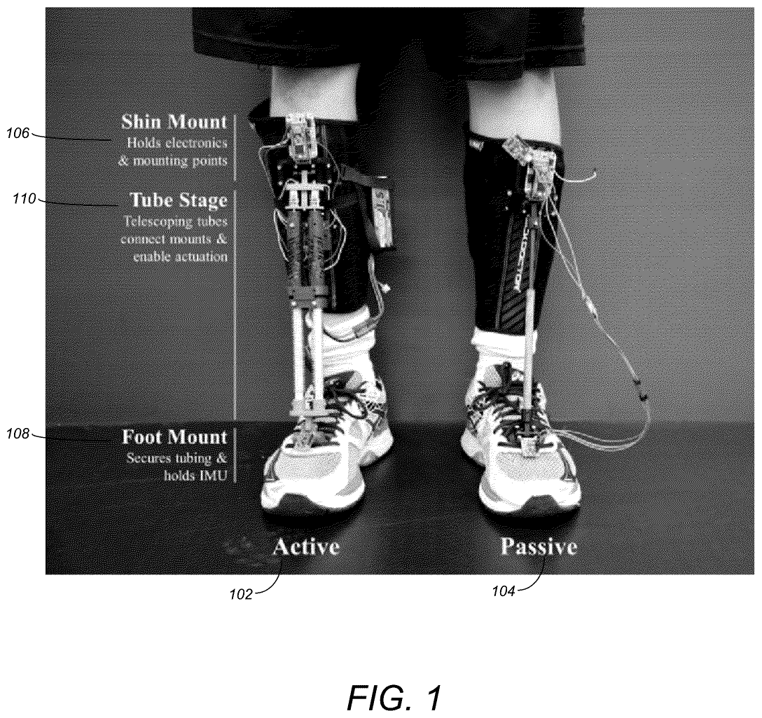

FIG. 1 illustrates two exemplary configurations of a front-leg ankle exoskeleton attached to a body in accordance with one or more embodiments of the invention. The active version 102 (left) takes advantage of the shin and foot mounting points to apply controlled forces to the body, while the passive version 104 (right) is purely a data collection platform. As illustrated, the shin mount 106 holds electronics and mounting points with the foot mount 108 securing the tubing and holding an inertial measurement unit (IMU). The tube stage 110 includes telescoping tubes/connectors and connect mounts which serve to enable actuation.

The ankle exoskeleton 102/104 exerts force on the user's body via two attachment points: one at the front of the shin (e.g., the shin mount 106), and one at the top of the foot (e.g., the foot mount 108). Between these attachment points 106-108, the device 102/104 has a linear segment (e.g., the tube stage 110 [also referred to as connector] that can extend and compress, allowing the connector 110 to apply variable torques to the ankle throughout the gait via unactuated springs, linear actuation, or a combination of the two. An example of this extension/compression timing is illustrated in FIG. 2. Accordingly, FIG. 2 illustrates an example control scheme for a front-leg ankle exoskeleton in accordance with one or more embodiments of the invention. As illustrated, during the initial contact 202, loading response 204, mid stance 206 and terminal stance 208 of the gait/stride, extension/compression is neutral 218. The gait/stride then proceeds to the pre-swing 210 and initial swing 212 stages during which there is an extension 220. Finally, during the mid-swing 214 and terminal swing 216 stages of the gait/stride, there is compression 222. Designs of the front-leg ankle exoskeleton of embodiments of the invention are smaller and more flexible than existing designs.

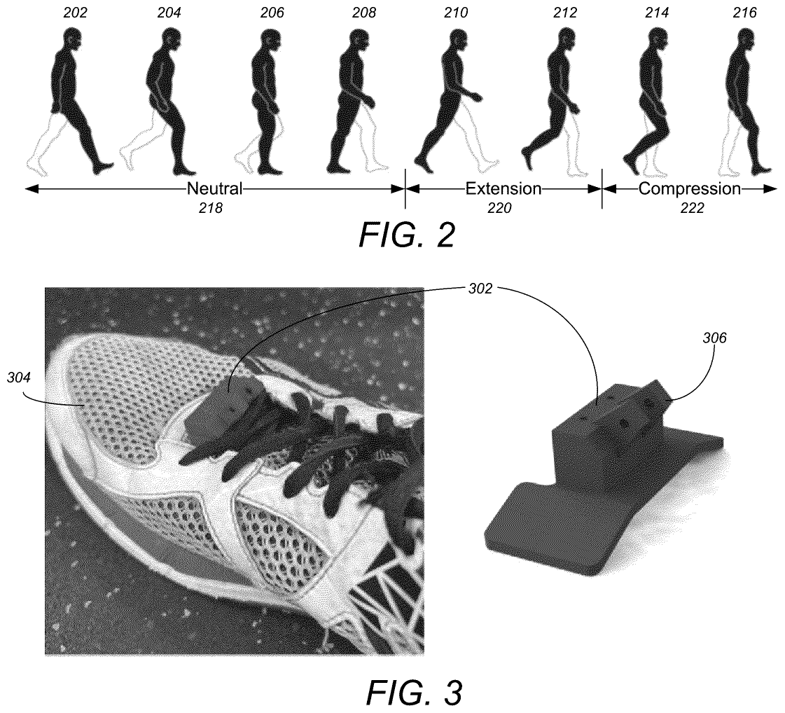

FIG. 3 illustrates an image and close-up of a shoe attachment piece in accordance with one or more embodiments of the invention. Specifically, the foot mount 302 (also referred to as shoe attachment 302) may be designed to fit snugly over the tongue of a typical shoe 304, while the shoe attachment 302 allows the exoskeleton to comfortably apply forces to the foot. As illustrated, the exoskeleton may be mounted to the foot attachment point via a custom shoe insert 302, designed to fit at the base of the tongue of a typical shoe 304. The shoe attachment 302 may be secured to the shoe 304 by shoelaces on top and pressure from the foot below. The bottom part of the insert 302 is padded to comfortably apply force to the top of the foot. The top part of the insert 302 rises above the shoe, and may host an IMU board and a customizable attachment point (e.g., attachment point 306). This modular piece 302 allows the user to use their own shoes 304 for the exoskeleton, unlike previous designs that required a custom pair of shoes for each user. A single shoe insert 302 is designed to work over a range of 2-3 US sizes. Additional modifications to the shoe insert can be made based on foot size for additional comfort.

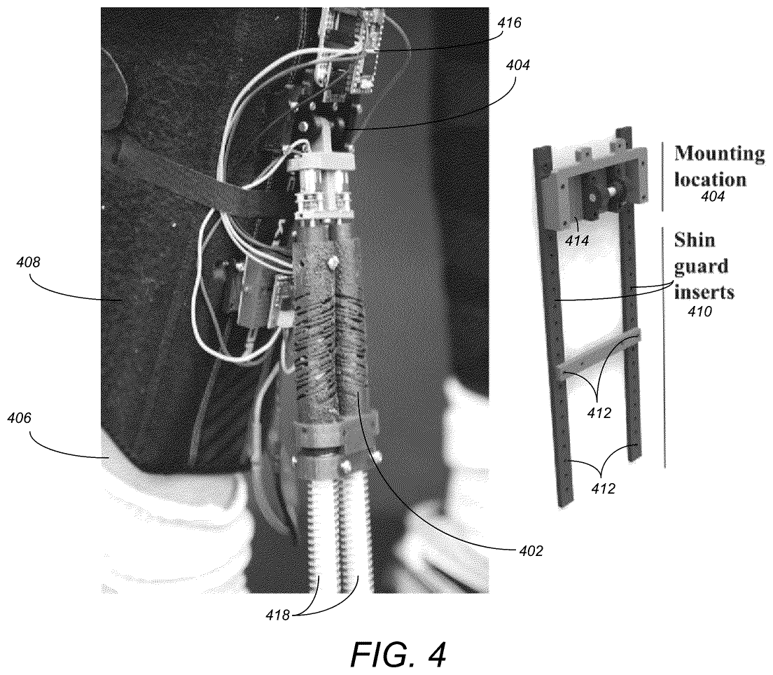

FIG. 4 illustrates a custom shin attachment/shin mount as part of a full ankle exoskeleton and hidden components in accordance with one or more embodiments of the invention. Two shin guard insert plates may provide a secure mounting location for the telescoping tube stage and control electronics. More specifically, as illustrated, the exoskeleton 402 may be mounted (e.g., via mount 404) to the anterior portion of the lower-leg 406 via a modified shin guard 408. The shin guard 408 may be based on a Shock Doctor 857 Calf-Shin Wrap. The padded vertical inserts 410 on this shin guard 408 may be modified to host evenly spaced screw attachment points (e.g., holes 412). A plate 414 attached to these inserts 410 may holds a programmable microprocessor 416, with built-in storage capabilities and access to IMUs on both the shin and the foot. This design allows for simple incorporation of a battery, telescoping tube, or other hardware.

Between these two attachment points (i.e., shin mount 106 and foot mount 108), an optional telescoping tube allows mounting of springs without buckling. This piece can be swapped to accommodate a pair of tubes (e.g., tubes 418 in FIG. 4), a linear actuator, or nothing at all. The choice of telescoping tube depends on the targeted application of the exoskeleton, three of which are described herein.

### Applications

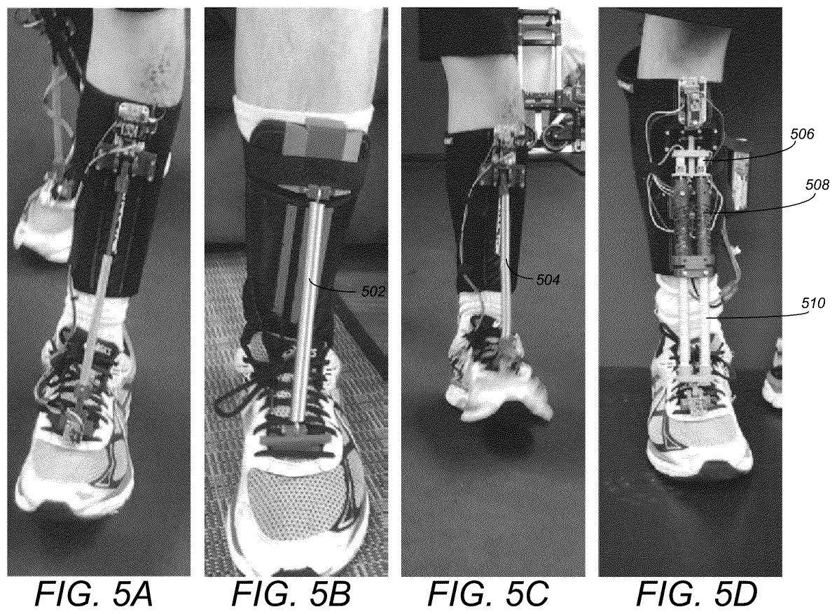

Embodiments of the invention may include various applications some of which are described herein. FIGS. 5A-5D illustrate variations of the front-leg ankle exoskeleton based on applications in accordance with one or more embodiments of the invention.

FIG. 5A illustrates the simplest application as a platform for measuring ankle angle in a controlled, repeatable way. In this setup, no actuated portion is needed. The shin and foot mounts securely hold IMUs to the body as the user walks, collecting data on ankle angle and forces. This application is useful for a wide variety of research purposes, including analyzing gaits under different conditions (speed, loads, environment) and across different human subjects. It also provides useful training data for predicting the gait timing phase variable from ankle pose, which is critical for control of actuated ankle exoskeletons.

The second application is passive gait augmentation. For example, placing an extension spring 502 (FIG. 5B) between the foot and shin mounts could help the user lift their foot during push-off (i.e., for assistance with toe lift). This would be particularly beneficial for those who suffer from foot drop, a common condition in older adults characterized by the inability to lift the foot while walking [Nori et. al. 2020]. Alternatively, a compression spring 504 (i.e., in FIG. 5C) could be placed between the foot and shin mounts for general passive assistance to the user as they walk (i.e., for assistance with push-off). The compression spring stores energy in between swing-foot contact and push-off, and then releases the energy during push-off to contribute to the sudden burst in power required from the ankle during level-ground walking.

The third application illustrated in FIG. 5D is active gait augmentation to efficiently reduce the associated cost of transport for the human user. A specific example of this application leverages a linear actuator to control the force applied by a spring. This creates a compliant system that can apply assistive force during push off and toe lift without inhibiting the user's regular walking motion. There is also room to incorporate springs that insulate the body from the direct forces of a rigid linear actuator. For example, FIG. 5D illustrates active ankle assistance using a rotary motor 506, a handed shearing auxetic (HSA) 508 and a compression spring 510.

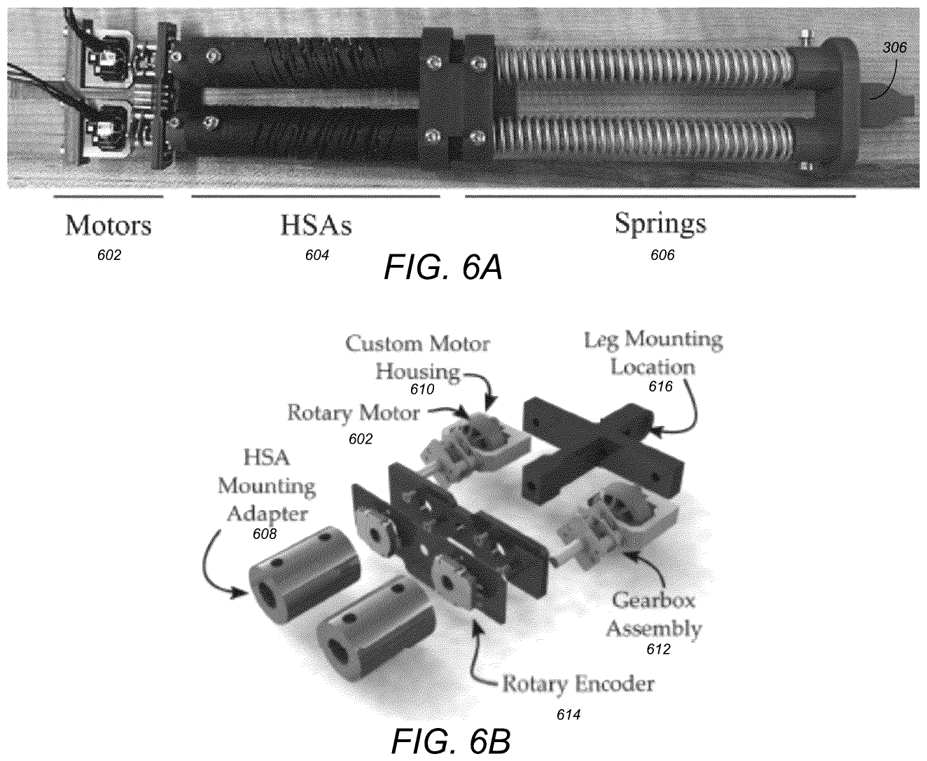

A more detailed illustration of such a linear actuator is illustrated in FIGS. 6A and 6B. In this regard, FIG. 6A illustrates the subcomponents of an HSA-spring design and FIG. 6B illustrates an exploded view of a motor assembly in accordance with one or more embodiments of the invention. As illustrated, embodiments of the invention use rotary motors 602 to apply a torque to a pair of Handed Shearing Auxetics (HSAs) 604 (that are mounted using HSA mounting adapter(s) 608) (see [Lipton et. al. 2018] and [Good et. al. 2021]). The HSAs 604 translate the rotation from the rotary motor 602 (which may be contained within custom motor housing 610 that is coupled to a gearbox assembly 612) (e.g., via one or more rotary encoders 614) into a linear displacement, modulating the displacement force exerted by the springs 606 (e.g., onto the leg via the leg mounting location 616 such as the shoe mount 306). Specifically, when a pair of left and right HSAs 604 are fixed together on one end, opposite torsional forces applied to the other end cause the pair to extend or contract [Lipton et. al. 2018], effectively creating a linear actuator. These HSAs 604 directly actuate a pair of springs 606 held on a telescoping tube, providing a controlled version of the passive exoskeleton's assistance. They are supported with a variety of control and feedback hardware, including two encoders that measure the position of the shaft, two electronic speed controllers, and a shin-mounted battery. The success of this design proves the versatility of the front-leg ankle exoskeleton as a general platform for improving walking and promoting research.

Further to the above, an additional description of the exoskeleton design and an application of the design is described below.

### Exoskeleton Design Using HSA-Based Linear Actuation

Embodiments of the invention may provide that ankle exoskeleton's design is driven by the use of HSA-based linear actuation to generate torques about the ankle. The design is divided into three subassemblies: (1) shoe attachment; (2) shin attachment; and (3) the linear actuation stage between them. Placement on the front of the leg braces the linear actuator on the shin and directs its forces onto the top of the foot. This positioning maximizes the moment that can be applied to the ankle during normal walking.

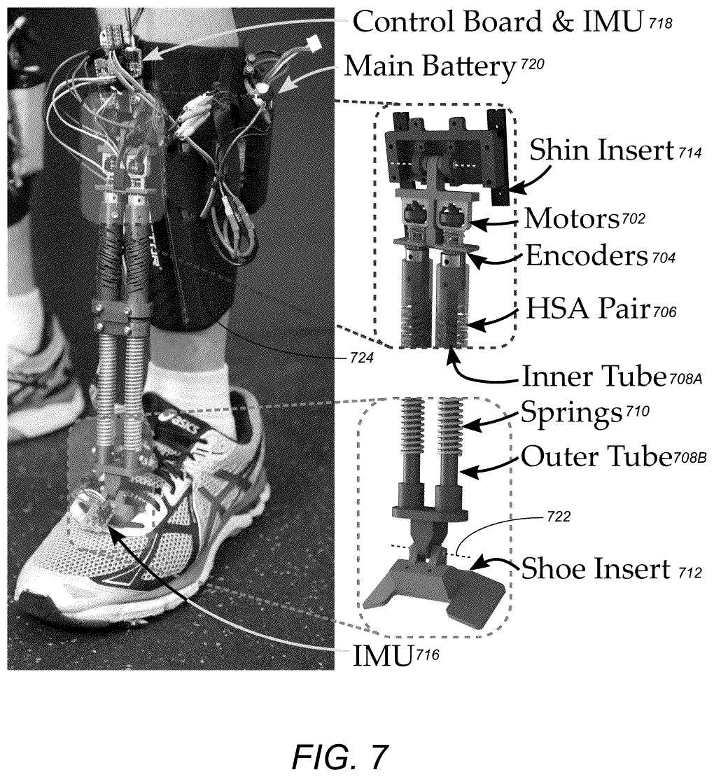

HSA compliance enables a lightweight and compact support structure, with the entire ankle exoskeleton weighing 490 grams/leg. Total torque is driven by choice of HSAs (described below). A full design of an exemplary exoskeleton is illustrated FIG. 7. As illustrated, rotary motors 702 actuate (via encoders 704) an HSA pair 706 mounted on telescoping tubes 708 (including inner tube 708A and outer tube 708B) to prevent buckling. Linear motion generated by the HSA pair 706 changes the displacement position of a pair of springs 710 mounted in series, modulating the force applied to the body. Shoe insert 712 and shin insert 714 securely attach the device to the body and carry electronics (e.g., IMU 716 carried by shoe insert 712; control board & IMU 718, and main battery 720 carried by shin insert 714).

### Motivation

With this device, embodiments of the invention seek to introduce a new class of assistive ankle exoskeletons that are lightweight, highly customizable, and reduce the metabolic cost of normal walking. Reducing exoskeleton weight with more compliant actuators makes the devices easier to wear and more robust to unpredicted movements. Customizability enables more effective control for individual users, and reducing the cost of walking for able-bodied individuals promises a broad range of benefits and an important step towards robotic devices for injury recovery.

Embodiments of the invention may use HSAs (or any other type of actuator) and meets these goals by enabling a compact linear actuator with a front-leg design and adjustable parameters. Paired with state estimation and control, embodiments of the invention achieve a metabolic reduction by targeting the push-off phase of the gait.

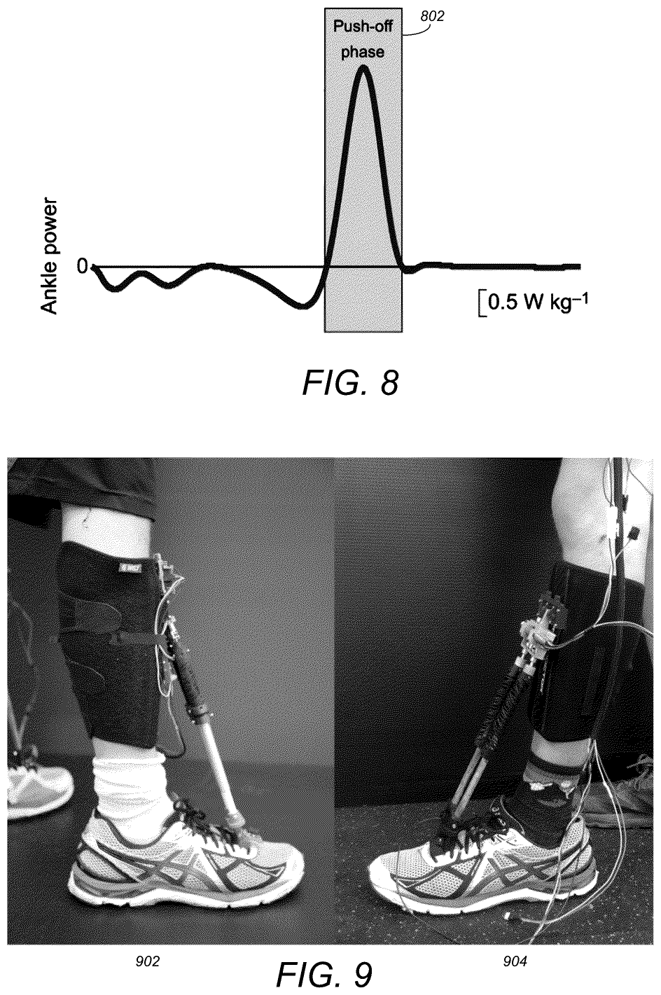

To meet the goal of reducing metabolic cost effectively, the exoskeleton must apply appropriate torques when the body needs it. Embodiments of the invention identified two possible gait periods for metabolic improvement: (1) just before push-off, for healthy individuals and (2) towards the end of the swing phase (e.g., phase 214 or 216 of FIG. 2), for those with drop-foot. Option (2) is particularly promising for the weak HSA actuator. Motivation for targeting the push-off period has precedent in gait moment analysis and exoskeleton design. From a gait moment perspective, FIG. 8 shows qualitatively how ankle power peaks during the push-off period, providing an opportunity for assistance. Specifically, as illustrated, the ankle generates a significant amount of the propulsive force for walking during the push-off phase 802, when the Achilles tendon generates a large ankle moment (e.g., primarily caused by the elastic recoil of the Achilles tendon). Note that this spike in power is temporary; there is a brief period immediately afterwards when push-off is still in progress but the body is incapable of applying additional ankle torque. Note that the steep drop-off in ankle power after the initial spike still occurs before the push-off phase is complete. This suggests that the body is particularly receptive to assistance during the end of the push-off phase, when the foot is still touching the ground but the recoil from the Achilles tendon is reduced. This period is one of the targets of the ankle exoskeleton of embodiments of the invention.

The above observations have been confirmed by a number of exoskeleton studies. [Antonellis et al., 2022] use a hip exoskeleton to demonstrate that propulsion-targeted assistance provides superior performance. On the ankle exoskeleton side, the parameterized control curve used by [Zhang et al., 2017] primarily targets push-off to achieve 24% metabolic reduction.

### Motivation for Front-Leg Design

A front-leg design is somewhat unusual among the last decade of ankle exoskeletons. Embodiments of the invention departs from the norm to take advantage of unique actuator capabilities. Embodiments of the invention simultaneously demonstrate that front-leg mounting allows versatile and lightweight attachment to the body.

Many of the most successful ankle exoskeleton designs rely on actuation located behind the leg [Slade et al., 2022] or moment arms positioned on either side of the leg [Mooney et. al. 2014] to produce a torque around the ankle. This paradigm traces back to a common feature among many previous exoskeleton designs: an operating mechanism that works better in tension than compression. The rope, in particular, is a feature of nearly every modern ankle exoskeleton design. In tension, it can transmit large forces to produce a desired moment, but in compression it lies in slack and does not transmit forces.

Rope-based designs are useful in part because of this variable stiffness property. The stiff tension behavior is conducive to transmitting forces, while the slack compressive behavior allows naturally efficient human dynamics to dominate at times when assistance is less efficient. However, the nature of this variable stiffness restricts its use in front-leg ankle exoskeletons. The control used by [Slade et al., 2022] and [Mooney et. al. 2014] and others specifically targets push-off when the plantarflexion angle increases rapidly. A front-leg design requires downward forces applied to the top of the foot, which is not directly achievable in tension.

The HSA-based linear actuator shares this variable-compliance property that makes rope so useful for ankle exoskeletons, but has a broader range of compliance behavior. A “closed” HSA may be designed to exert greater forces in compression than tension, allowing it to push off the top of the foot. In contrast, an “open” HSA generally exerts greater forces in tension, and a “half-open” HSA is capable of high stiffness in both modes. Informed HSA design, described herein, enables an effective front-leg ankle exoskeleton. Additionally, some of the oldest pneumatics-based ankle exoskeleton designs use a front-leg mount, in part because pneumatics are able to exert forces in tension or compression [Ferris et al., 2006].

A key advantage of mounting actuation on the front of the leg is lightweight attachment. Rope-based designs that operate on the back on the leg require a heavily custom shoe [Mooney et. al. 2014] or significant shoe modification [Galle et al., 2017]. A front-leg design allows for lightweight shoe inserts that are adjustable for any shoe size.

### Mechanical Design Details

### Shoe Attachment

Referring to FIG. 7, the exoskeleton is mounted to the top of the foot via a 3D printed custom shoe insert 712, designed to fit at the base of the tongue of a typical laced shoe. It is secured to the shoe by shoelaces on top and pressure from the foot below. The bottom part of the insert 712 is padded to comfortably apply force to the top of the foot. The top part rises above the shoe, holding a lightly constrained revolute connection to the linear actuation stage and a 9-axis inertial measurement unit (IMU). This modular piece (i.e., the shoe insert 712) allows the user to use their own shoes for the exoskeleton. A single shoe insert 712 may be used across different shoes and 2-3 US shoe sizes.

The shoe insert's revolute joint uses a pin connected through a larger hole 722 to loosely constrain foot rotation. This leaves doris- and plantarflexion unconstrained while providing some compliance in the lateral and medial directions.

### Linear Actuation Stage

The linear actuation stage between the foot and shin attachment points uses a pair of HSAs 706 connected in series with parallel traditional springs 710 (keff=1.8 N/mm). The springs 710 effectively override the dynamic spring constant of the HSAs 706, preserving the linear actuation property but insulating from stiffness changes. HSA motion is driven by a pair of rotary motors 702 attached to the shin wrap 724. When these motors 702 are driven in opposite directions, their torque causes the HSA assembly to extend or contract, changing the equilibrium position of the springs 710 and pushing on the top of the foot. This creates a compliant system that can apply assistive force during push off without inhibiting the user's regular walking motion. To preserve HSA stiffness and prevent transverse bending, the linear actuation stage contains a complementary pair of telescoping tubes 708.

### Shin Attachment

A modified shin wrap 724 secures the ankle exoskeleton to the anterior portion of the lower leg. This shin wrap 724 may be based on the SHOCK DOCTOR 857 CALF-SHINWRAP, which tightly attaches to the lower leg. Embodiments of the invention may modify the padded vertical inserts on the 857 to provide a secure mounting location for one end of the linear actuation stage and key electronics 718-720. Unlike the joint on the shoe insert 712, the shin's connection to the linear actuator is a strict revolute joint. This freedom allows the user to change the angle between their foot and their leg but constrains lateral motion that may inhibit the exoskeleton's actuation.

For the drone motor variant of the design, the shin wrap 724 may also host the majority of the electronics (e.g., control board and IMU 718 and/or main battery 720) needed to drive the device. A control board 718 may be mounted to the shin inserts 714 just above the revolute joint. The control board 718 also includes an IMU, electronic speed controllers, and 2.4 GHz two-way wireless communication. Data from the IMUs at the shin and the foot 716 may separately undergo a standard Kalman filtering to estimate orientation. The exoskeleton transmits the relative quaternion, representing ankle angle, at a frequency of 100 Hz. A wire connecting to the shoe insert is required for this estimate. Power for this control board may be provided by a small 1S lithium-polymer battery mounted between the board and the shin wrap 724.

Supporting electronics for control are connected to the shin control board 718. These may include a force-sensitive resistor (FSR) located below the heel, a load cell in-line with the HSA stage, and motor encoders. Motor power may be provided by a 3S lithium-polymer battery 720 held in a pouch sewn onto the body of the shin wrap 724. Note that the worm gearbox variant of the design may locate battery 720 and electronics 718 at the hip.

For user customization, the shin wrap's mounting height may be adjusted. The nominal location illustrated in FIG. 7 positions the linear actuation stage in an equilibrium position at stance. This position occurs when both the HSAs 706 and compression springs 710 are at their zero potential energy state. Users navigate to this state by adjusting the height of the shin wrap until the springs 710 just begin to touch the base of the foot mount.

### Hip Attachment

For a worm gearbox variant of embodiments of the invention, the electronics (e.g., the control board, battery, etc.) are located entirely at the hip apart from several key sensors (IMU, FSR, load cell) and the motors 702 themselves. The hip pouch is split into a battery compartment housing a 5S lithium-polymer battery and an electronics compartment housing the control board. The control board may include a TEENSY 4.1 with SD card logging, two electronic speed controllers (one for each leg), 2.4 GHz low-energy Bluetooth for wireless communication. Unlike the drone motor design, data is logged directly to the SD card and wireless communication is used only for commands. Additionally, the control board manages exoskeletons on both legs simultaneously.

### Actuation

The basic ankle exoskeleton design accommodates a wide range of actuation mechanisms, including passive and active designs. Embodiments of the invention tested designs with passive spring dynamics, drone motors, and a worm gearbox design. In each case, the design was optimized for weight, actuation surfaces, and durability. FIG. 9 illustrates a comparison of these designs. Specifically, the drone motor design 902 (left) and the worm gearbox design 904 (right) are illustrated. Both designs 902-904 share the majority of mounting hardware, but differ in their motor configuration. The worm gearbox design 904 drives both HSAs with a single motor and has electronics at the hip, while the drone motor design 902 directly drives both HSAs with shin mounted electronics.

### Passive Dynamics Design

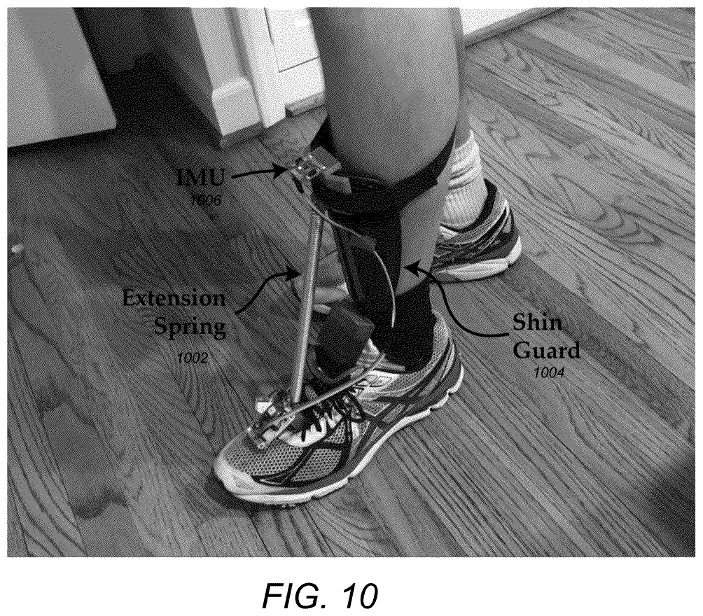

The first iteration of the ankle exoskeleton utilized the structure described above with a passive actuation mechanism replacing the HSAs. The goal of this design was to test the bodily attachment points under loads on the same order as the HSAs. This design may also be used for a qualitative estimate of how low force HSA assistance could influence walking. FIG. 10 illustrates a passive extension-spring ankle exoskeleton in accordance with one or more embodiments of the invention. The ankle exoskeleton used a single extension spring 1002 or a pair of compression springs between the foot and shin mounts. This design was particularly useful for testing the exoskeleton's shin and shoe mounts, and for qualitatively predicting what an active HSA-based design might feel like.

Embodiments of the design illustrated in FIG. 10 replaced the HSA actuation stage with a single row of springs 1002 enclosing a telescoping tube. A shin guard 1004 was used to attach the device and contained a mount/pocket for an IMU 1006. To test the compressive effects of HSAs, a passive dynamics actuation stage was assembled with two compression springs 1002 in series (k_{eff}=7.2 N/mm). The springs 1002 were only attached at the shin, preventing them from applying forces in tension. This design was primarily targeted at testing possible push-off assistance. To test assistance targeted at drop-foot, a single extension spring 1002 (k=0.415 N/mm) attached at both the shin and the foot with no telescoping tube was used. Shin height was adjusted so the spring 1002 only pulled towards the end of the swing phase, protecting the user from drop-foot.

### Drone Motor Design

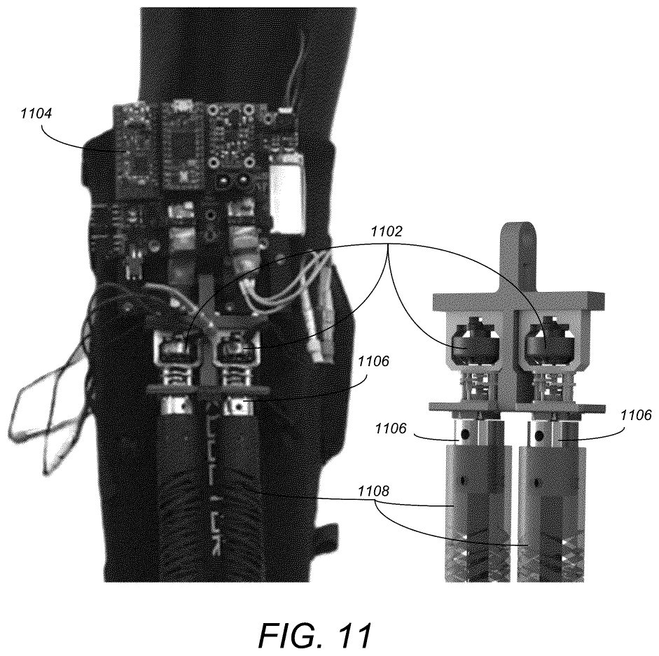

FIG. 11 illustrates a drone motor design in accordance with one or more embodiments of the invention. The drone motor design directly drives each HSA with a rotary brushless motor (e.g., FLYWOO 5150 KV) 1102 coupled to a commercial gearbox (e.g., a POLOLU 100:1 gearbox). All electronics are mounted above on a single custom PCB (printed circuit board) 1104. The motor output shaft feeds through rotary encoders 1106 that measure the angle of rotation of each HSA for precise control and feedback. The entire spring-HSA system is mounted on a pair of telescoping tubes 1008 that guide the force onto the top of the foot and prevent buckling.

The specific motors 1108 may be chosen to minimize weight. Driven at 11.1 V (a 3S battery), the motors 1108 may have a no-load speed of 57,165 rpm. After gear reduction, this speed may be reduced to about 570 rpm. The reported maximum power of the motor 1108 is 55 W, but testing suggests the true power may be substantially lower.

### Worm Gearbox Design

The brushless drone motor design is lightweight but incapable of applying enough torque to quickly move HSAs. Additionally, it fails to take advantage of the inherent symmetry of the task, requiring some low-level control to enforce zero-net-torque actuation. The drone motor design also suffers from frequent component breakage and back-drivability, which compromises the inherent compliance of HSAs, increases wear, and complicates control.

To counter these issues, embodiments of the invention may provide a drive system specifically for HSAs. The gearing enforces that the two output shafts rotate in opposite directions with the same gear ratio (excluding backlash). Such embodiments may also use a worm gear to prohibit back-drivability and protect the actuating electronics. It's driven by a single powerful motor for each leg. The result is a compact, specialized drive system that produces linear actuation with minimal overhead.

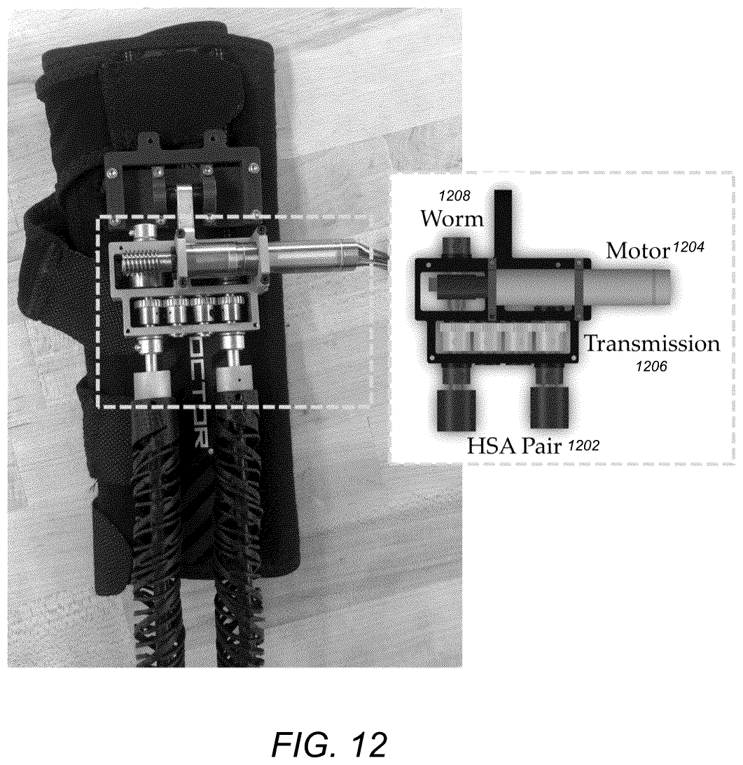

FIG. 12 illustrates a worm gearbox design in accordance with one or more embodiments of the invention. Rather than actuate the two HSAs independently, the worm gearbox rotates both HSAs 1202 in opposite directions with the same motor 1204 (e.g., a single brushless motor 1204) via transmission 1206. It also includes a worm 1208 that prevents back-drivability and a 50 W brushless motor.

In one or more embodiments, the motor 1204 may be a MAXON ECX SP 13L with a no-load speed of 65,800 rpm, a stall torque of 0.163 Nm, and a rated power of 50 W. A MAXON gearbox with ratio 5.3:1 may be included on the output shaft of the motor. The output shaft is connected to a worm-worm gear configuration 1208 that adds a 20:1 reduction and directly turns one HSA 1202. The other HSA 1202 is connected through four identical spur gears so it rotates in the opposite direction. This leaves the final gear ratio at 106:1. The output no-load speed is 621 rpm, and the output stall torque is 17.3 Nm. HSA loads are not expected to exceed 0.2 Nm. At this load and with a 19 V supply (5S lithium-polymer battery), the expected motor speed is 485 rpm. This allows rapid rotation through the useful range of the auxetic trajectory, greatly improving the capabilities of the exoskeleton.

### HSA Selection

### Minimum Viable Forces

To use HSAs in an exoskeleton they must be capable of applying enough force to provide noticeable assistance. As a conservative estimate, embodiments of the invention may assume an inclined tube must be able to at least lift the weight of an adult foot (about 1 kg for a 60 kg person [Plagenhoef et. al. 1983]). This conservative estimate puts the minimum viable force at 14 N, which HSAs are capable of applying at their peak. With embodiments of the invention, 14 N translates to about 1.2 Nm of torque applied to the ankle. For comparison, many large exoskeletons apply up to 300 N of force at their peak and maximum torques of around 50 Nm [Mooney et. al. 2014]. With lower torques one can expect some metabolic cost reduction for carefully timed assistance, but it may be unlikely to achieve the 20% or more energy cost reductions observed with high-torque exoskeletons.

### HSA Parameters

HSA selection is inherently tied to control. Historical developments with ankle exoskeletons relied on either (a) muscle-based control or (b) a tuned torque profile. Muscle-based control is particularly appealing for HSAs because of their variable stiffness property. If an HSA is designed to have parameters that were similar to a specific muscle along its auxetic trajectory, one could use the HSA to replace that muscle. While this is an appealing concept, this would require a more robust understanding of HSA parameter design than currently exists. Accordingly, embodiments of the invention may select HSA parameters based on a tuned torque profile (parameterized) control framework.

For parameterized control, the spring constant of the HSAs can be effectively overwritten with low stiffness springs in parallel and the HSAs behave like simple linear actuators. HSAs were designed and printed to exhibit a maximum length extension of 60 mm and a maximum length contraction of 10 mm. With these parameters, the HSA can extend to accommodate the large foot-to-shin distance during push-off and retract to prevent contact when the foot moves closer to the shin during swing. FIG. 13 illustrates true HSA displacement and spring constant values in accordance with one or more embodiments of the invention. The independent variable (theta) 1302 represents the angle at which one end of the HSA was tested. Displacement 1304 is enforced by external clamps. The HSA is printed at 15% extension. Note that the spring constant 1306 increases with displacement 1304 from zero-force location and with angle of rotation.

### Control Methodology

The exoskeleton's control targets assistance during the push-off phase of a user's gait. A control algorithm may consist of a parameterized curve that can be tuned for each individual user with preference-based learning or a parameter sweep. For the weaker, slower drone motor design embodiments of the invention may use a simple two-parameter bang-bang control. The discontinuous jumps are smoothed by slow motor dynamics. The worm gearbox design enables a much wider variety of complex control curves that include smoothing and more parameters.

### Bang-Bang Control

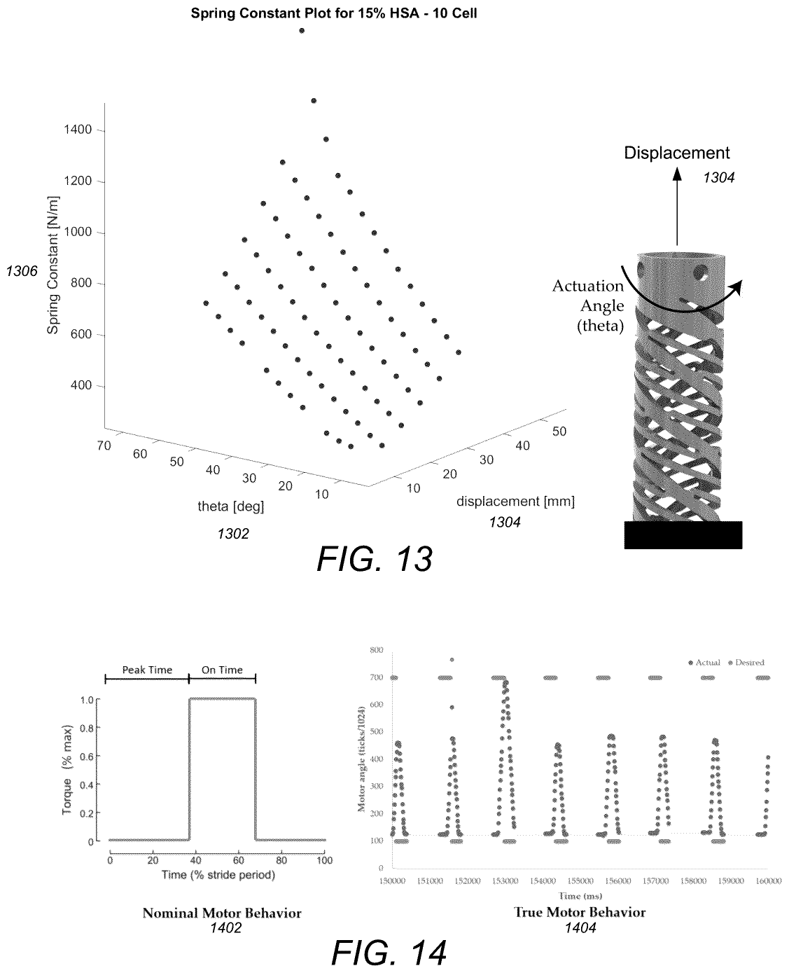

The basic control algorithm utilized (by one or more embodiments of the invention) may be a bang-bang control (illustrated in FIG. 14) because of the low force capabilities of HSA actuators. As illustrated, a bang-bang control paradigm (i.e., nominal motor behavior) 1402 may be used to generate assistive torques. This style of control takes full advantage of the relatively weak HSA actuators. However, real angle data 1404 (i.e., true motor behavior) from the device suggests that this idealized curve was not achieved in practice. Assistance timing is determined by heel strike detection and a set of tunable time variables. The exoskeleton's heel-mounted FSR reliably detects heel strikes and records a rolling average of the user's step time. A tunable parameter s controls the time offset from heel strike at which actuation begins. This is stored as a percentage of total step time. Another parameter, Δs, determines the length of actuation in terms of the total step time. The HSAs are extended to their maximum safe length while actuated. After actuation, the HSAs are briefly retracted before returning to their zero-energy state.

Given the low torque capabilities and slow speed of the drone motor design, the nominal behavior 1402 of bang-bang control is practically impossible. The true behavior 1404 of the output is closer to a spike than a square wave. Note that this is somewhat similar to the behavior of the biological power applied by the human during normal walking (FIG. 8).

### Experimental Demonstration

A number of isolated metabolic cost and muscle activity tests were performed with the ankle exoskeleton.

Electromyography with Drone Gearbox

The effect of our ankle exoskeleton was experimentally demonstrated for a single subject using electromygraphy (EMG) on specific muscles. The subject was a healthy young adult female with no disabilities. The subject was asked to walk on the treadmill continuously for three minutes at two different speeds (1.5 mph or 0.67 m/s, and 2.0 mph or 0.89 m/s) for the following three settings: wearing the exoskeleton with assistance provided, wearing the exoskeleton but no assistance provided, and without the exoskeleton. Before testing, the subject was asked to adjust the shin wrap height for comfortable walking. The shin wrap was raised to disengage the springs before the no assistance trial. The subject used the same shoes between the three settings.

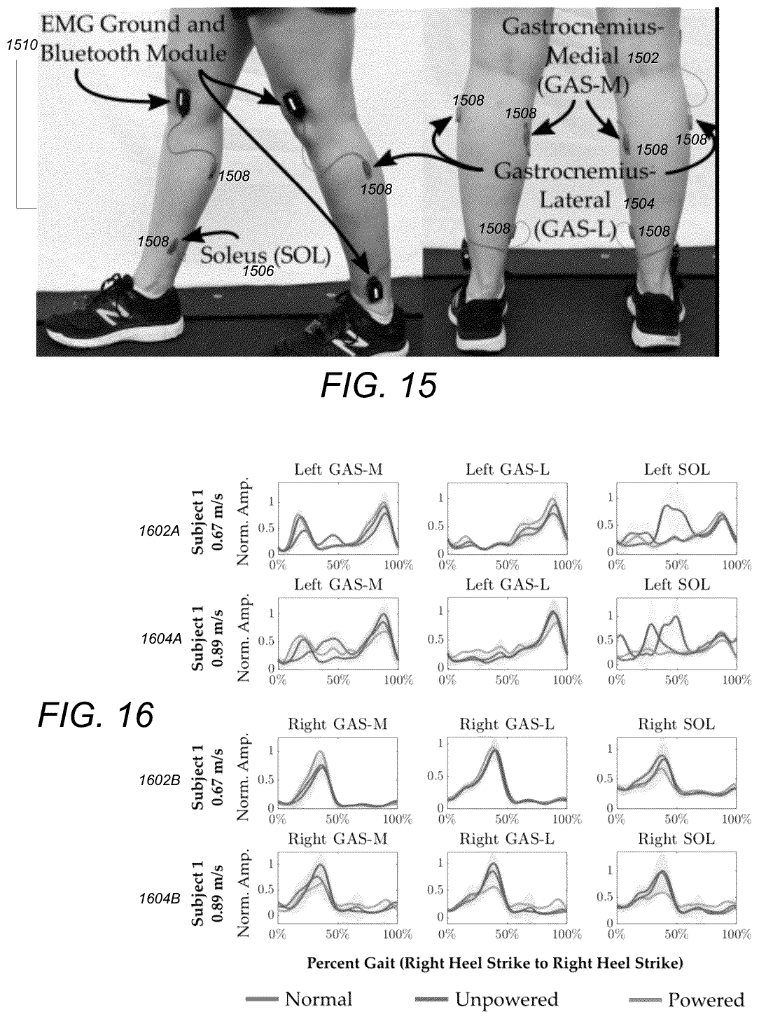

During all settings, in a total of 18 minutes, electromyography (EMG) signals were recorded with the COSMED TRIGNO wireless biofeedback system (DELSYS INC.) with mini-sensors. Specifically, the activity of six muscles were recorded using EMG mini-sensors, including medial gastrocnemius (GAS-M) 1502, lateral gastrocnemius (GAS-L) 1504, and soleus (SOL) 1506 on each leg. FIG. 15 shows the placement of EMG sensors in accordance with one or more embodiments of the invention. Each mini sensors has a EMG surface-mount sensor 1508 and a larger module 1510 that houses an inertial measurement unit (IMU) sensor, a Bluetooth module, and records EMG ground.

### Electromyography Results

The EMG results are shown in FIG. 16. The EMG results for subject 1 are presented for both a slower speed (1.5 mph or 0.67 m/s) 1602A and 1602B and a faster speed (2 mph or 0.89 m/s) 1604A and 1604B. Both trials were conducted for 3 minutes on a treadmill. The EMG signals were then processed separately for each muscle, normalized to the maximum amplitude per muscle across both trials, and averaged across each complete gait cycle. The gait cycles begin with right heel strike. As illustrated, for the faster walking speed 1604A and 1604B a large reduction in soleus muscle activity was observed during the push-off portion of the gait. A small increase in activity occurred during the swing portion. Additionally, the use of the exoskeleton when unpowered did not significantly affect the muscle activity.

These results were not uniform for both legs and across muscles. While the right soleus showed significant decline in muscle activity, it is difficult to compare the left soleus data across trials. An EMG sensor shift may have caused the drastic difference between the normal and unpowered walking for this reading. For the other two muscles measured, EMG reduction was significantly higher for the faster walking speeds.

Metabolic Cost Tests with Drone Gearbox

The effects of the ankle exoskeleton (of embodiments of the invention) on metabolic cost of transport were tested through several walking trials with a single subject. The subject was a healthy young adult male with no disabilities.

### Experimental Procedure

Before each trial, the user self-tuned exoskeleton timing heuristically. A sweep of activation times s from 25% to 35% of the gait was performed at 1% increments. After the parameter sweep the user selected their preferred percentage and the powered exoskeleton setting proceeded. During all settings (9 minutes total), metabolic cost of transport was recorded using a COSMED k4b2. Additionally, exoskeleton data was wirelessly recorded. This included compressive spring force, ankle angle, heel force, and motor commands.

### Metabolic Cost Results

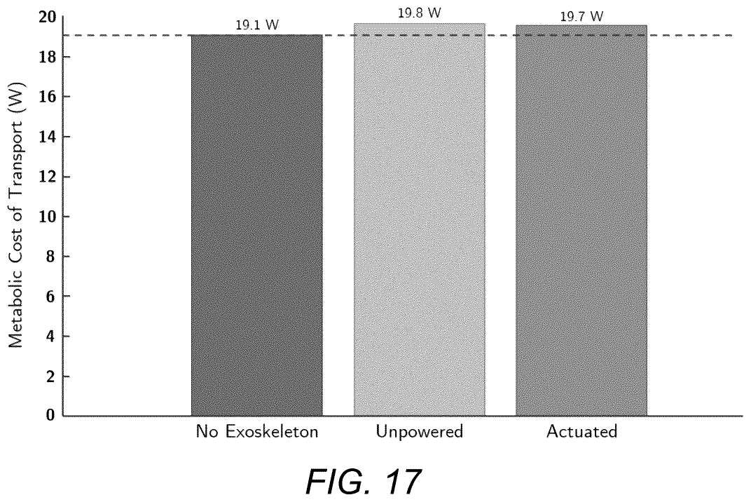

FIG. 17 illustrates the metabolic cost results in accordance with one or more embodiments of the invention. While they clearly show wearing the exoskeleton increases the metabolic cost of transport, they do not demonstrate any benefit to powered exoskeleton assistance. Compared to the no assistance setting, applying assistance at 31% of the gait had almost no effect on the metabolic cost of transport. Wearing the exoskeleton did increase metabolic cost, but only by a relatively small amount. Accordingly, assisted and unassisted walking had nearly identical metabolic costs that were just above the metabolic cost of walking without wearing a powered or unpowered exoskeleton.

### Exoskeleton Embodiments and Features

As described above, embodiments of the invention provide a front-leg assistive exoskeleton.

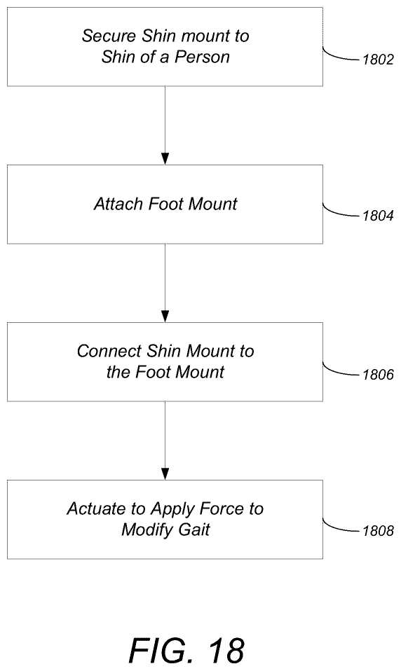

Referring to FIG. 1, and FIG. 18 (showing the logical flow of one or more embodiments of the invention), a shin mount 106 includes a material (e.g., a fabric or other type of material) that secures (e.g., via hook and loop fasteners, buttons/snaps, clips, or other type of mechanism) to a shin of a person such that the shin mount is enabled to push and pull on the shin in a normal direction (i.e., step 1802 of FIG. 18). In one or more embodiments, the material wraps around the shin to secure the shin mount to a leg of the person. Further, the shin mount 106 may include an attachment mechanism to attach electronic components for the exoskeleton. In addition, the shin mount 106 may attach to a sock or pants.

Further, a foot mount 108 attaches to a top of a shoe (i.e., step 1804 of FIG. 18). The foot mount may attach to the top of the shoe via an attachment piece inserted at a base of the shoe tongue. Alternatively, or in addition, the foot mount 108 may include two tabs that secure the foot mount to the top of the shoe by extending beyond the shoe tongue within the shoe. Alternatively, or in addition, the foot mount 108 may attach via holes in the shoe (e.g., in sandals or other types of shoes). The foot mount 108 may also carry an inertial measurement unit (IMU). In such embodiments, the IMU measures a relative angle between the foot and the shin, the relative angle determines a gait state of the person, and the gait state determines the forces that generates the torque. Further to the above, the foot mount 108 may include an attachment pin joint for attaching the connector. In such embodiments, the attachment pin joint may enable a rotation about an ankle joint without fully constraining a perpendicular rotational degree of freedom about the ankle joint.

In one or more embodiments, the foot mount 108 may be molded based on a shape of a foot of the person. Further, the foot mount may be customizable for the person via three-dimensional (3D) printing.

A connector 110 (e.g., a tube stage 110) connects the shin mount 106 to the foot mount 108 (i.e., step 1806 of FIG. 18). The connector 110 houses an actuator that applies forces that generates torque about the ankle that modifies a gait of the person (i.e., step 1808 of FIG. 18). In one or more embodiments, the connector 110 also includes/consists of one or more telescoping tubes that dynamically change a distance between the shin mount 106 and the foot mount 108. In addition, the connector 110 may include a spring that changes a force profile of the actuator and stores a potential energy triggered by the actuator. In such embodiments, the potential energy is converted to a kinetic force via a motion of the leg or foot.

### Alternative Embodiments

Embodiments of the invention may also provide for control algorithms that are paired with accurate state estimation of where the user is in the gait and where the user intends to move. Additional applications include the ability for HSAs that are customized/designed to fit the user or to replace or train a muscle. HSA-based exoskeletons have inherent compliance that is difficult to take advantage of without co-design of control with HSA parameters. The benefits of this co-design could include devices that assist with injury recovery or allow their user to carry heavier loads or help their user train for an event.

### CONCLUSION

This concludes the description of the preferred embodiment of the invention. The following describes some alternative embodiments for accomplishing the present invention. Embodiments of the invention may provide various contributions: (1) the novel design of an ankle exoskeleton that utilizes Handed Shearing Auxetics (HSAs) (or other actuators) and minimal user-specific hardware; (2) experimental demonstration of the device across a single subject.

The novelty of the design provides various advantages including that the design mounts to the anterior portion of the lower leg. This leads to less protrusion from the body, allowing the user to cross their legs freely. An additional advantage is that embodiments of the invention may leverage HSAs, which provide a lightweight and flexible mechanism for translating rotational torques into linear translations. Further embodiments may include metabolic cost measurements with more subjects, a systematic method (such as preference-based learning) of tuning the user-specific control parameters for each subject, and evaluating the effect of actuation timing on varying walking speeds.

Overall, embodiments of the invention provide a novel ankle exoskeleton design capable of moving the field towards more lightweight and flexible devices, a promising advancement for the field of wearable devices.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

### REFERENCES

[Antonellis et. al. 2022] Antonellis, Prokopios et al. (March 2022). “Metabolically efficient walking assistance using optimized timed forces at the waist”. In: Science Robotics 7.64. doi: 10.1126/scirobotics.abh1925. url: https://doi.org/10.1126/scirobotics.abh1925.
[Collins et. al. 2015] Collins, Steven H., M. Bruce Wiggin, and Gregory S. Sawicki (April 2015). “Reducing the energy cost of human walking using an unpowered exoskeleton”. In: Nature, vol. 522, no. 7555, pp. 212-215.
[Ferris et. a. 2006] Ferris, Daniel P., K. E. Gordon, G. S. Sawicki, and A. Peethambaran, (2006). “An improved powered ankle-foot orthosis using proportional myoelectric control”. In: Gait and Posture, vol. 23, no. 4, pp. 425-428, June 2006. issn: 0966-6362. doi: https://doi.org/10.1016/j.gaitpost.2005.05.004. url: https://www.sciencedirect.com/science/article/pii/S0966636205001049.
[Galle et. a. 2013] Galle, S. et al. (July 2013). “Adaptation to walking with an exoskeleton that assists ankle extension”. In: Gait and Posture 38.3, pp. 495-499. doi: 10.1016/j.gaitpost.2013.01.029. url: https://doi.org/10.1016/j.gaitpost. 2013.01.029.
[Galle et. a. 2017] S. Galle, P. Malcolm, S. H. Collins, and D. D. Clercq (April 2017). “Reducing the metabolic cost of walking with an ankle exoskeleton: interaction between actuation timing and power”. In: Journal of NeuroEngineering and Rehabilitation, vol. 14, no. 1. doi: 10.1186/s12984-017-0235-0. url: https://doi.org/10.1186/s12984-017-0235-0.
[Good et. al. 2021] Good, Ian et al. (2021). “Expanding the Design Space for Electrically-Driven Soft Robots through Handed ShearingAuxetics”. In: arXiv preprint arXiv:2110.00669.
[Gordon et. al. 2007] K. E. Gordon and D. P. Ferris, “Learning to walk with a robotic ankle exoskeleton,” Journal of Biomechanics, vol. 40, no. 12, pp. 2636-2644, January 2007. [Online]. Available: https://doi.org/10.1016/j.jbiomech.2006.12.006
[Johansson et. a. 2019] Johansson, Melker Staffan et al. (October 2019). “Time spent cycling, walking, running, standing and sedentary: a cross-sectional analysis of accelerometer-data from 1670 adults in the Copenhagen City Heart Study”. In: BMC Public Health 19.1. doi: 10.1186/s12889-019-7679-z. url: https://doi.org/10.1186/s12889-019-7679-z.
[Kao et. a. 2010] Kao, Pei-Chun, Cara L. Lewis, and Daniel P. Ferris (January 2010). “Invariant ankle moment patterns when walking with and without a robotic ankle exoskeleton”. In: Journal of Biomechanics 43.2, pp. 203-209. doi: 10.1016/j.jbiomech.2009.09.030. url: https://doi.org/10.1016/j.jbiomech.2009.09.030.
[Lipton et. al. 2018] J. I. Lipton, R. MacCurdy, Z. Manchester, L. Chin, D. Cellucci, and D. Rus (2018). “Handedness in shearing auxetics creates rigid and compliant structures”. In: Science, vol. 360, no. 6389, pp. 632-635.
[Mooney et. a. 2014] Mooney, Luke M, Elliott J Rouse, and HughMHerr (2014). “Autonomous exoskeleton reduces metabolic cost of human walking during load carriage”. In: Journal of NeuroEngineering and Rehabilitation, vol. 11, no. 1, p. 80.
[Mooney et. al. 2016] Mooney, Luke M. and Hugh M. Herr (January 2016). “Biomechanical walking mechanisms underlying the metabolic reduction caused by an autonomous exoskeleton”. In: Journal of NeuroEngineering and Rehabilitation 13.1. doi: 10.1186/s12984-016-0111-3. url: https://doi.org/10.1186/s12984-016-0111-3.
[Nori et. al. 2020] S. L. Nori and M. F. Stretanski, “Foot drop,” November 2020. [Online]. Available: https://www.ncbi.nlm.nih.gov/books/NBK554393/
[Plagenhoef et. al. 1983] Plagenhoef, Stanley, F. Gaynor Evans, and Thomas Abdelnour (June 1983). “Anatomical Data for Analyzing Human Motion”. In: Research Quarterly for Exercise and Sport 54.2, pp. 169-178. doi: 10.1080/02701367.1983.10605290. url: https://doi.org/10.1080/02701367.1983.10605290.
[Slade et. al. 2022] Slade, Patrick et al. (October 2022). “Personalizing exoskeleton assistance whilewalking in the real world”. In: Nature 610.7931, pp. 277-282. doi: 10.1038/s41586-022-05191-1. url: https://doi.org/10.1038/s41586-022-05191-1.
[Takahashi et. al. 2015] Takahashi, Kota Z, Michael D Lewek, and Gregory S Sawicki (2015). “A neuromechanics based powered ankle exoskeleton to assist walking post-stroke: a feasibility study”. In: Journal of neuroengineering and rehabilitation 12.1, pp. 1-13.
[Truby et. al. 2021] Truby, Ryan L, Lillian Chin, and Daniela Rus (2021). “A recipe for electrically driven soft robots via 3d printed handed shearing auxetics”. In: IEEE Robotics and Automation Letters 6.2, pp. 795-802.
[Zelik et. al. 2016] Zelik, Karl E. and Peter G. Adamczyk (December 2016). “A unified perspective on ankle push-off in human walking”. In: Journal of Experimental Biology 219.23, pp. 3676-3683. doi: 10.1242/jeb.140376. url: https://doi.org/10.1242/jeb.140376.
[Zhang et. al. 2017] Zhang, Juanjuan et al. (2017). “Human-in-the-loop optimization of exoskeleton assistance during walking”. In: Science 356.6344, pp. 1280-1284.

What is claimed is:

1. A front-leg assistive exoskeleton comprising:
a shin mount comprising a material that secures to a shin of a person such that the shin mount is enabled to push and pull on the shin in a normal direction;
a foot mount that attaches to a top of a shoe; and
a connector that connects the shin mount to the foot mount, wherein the connector houses an actuator that applies forces that generates torque about an ankle that modifies a gait of the person.

2. The front-leg assistive exoskeleton of claim 1, wherein the material wraps around the shin to secure the shin mount to a leg of the person.

3. The front-leg assistive exoskeleton of claim 1, wherein the shin mount comprises an attachment mechanism to attach electronic components for the exoskeleton.

4. The front-leg assistive exoskeleton of claim 1, wherein the connector comprises one or more telescoping tubes that dynamically change a distance between the shin mount and the foot mount.

5. The front-leg assistive exoskeleton of claim 1, wherein the connector comprises a spring that changes a force profile of the actuator and stores a potential energy triggered by the actuator, wherein the potential energy is converted to a kinetic force via a motion of the leg or foot.

6. The front-leg assistive exoskeleton of claim 1, wherein the foot mount attaches to the top of the shoe via an attachment piece inserted at a base of the shoe tongue.

7. The front-leg assistive exoskeleton of claim 1, wherein the foot mount carries an inertial measurement unit (IMU), wherein:
the IMU measures a relative angle between the foot and the shin;
the relative angle determines a gait state of the person;
the gait state determines the forces that generates the torque.

8. The front-leg assistive exoskeleton of claim 1, wherein the foot mount comprises two tabs that secure the foot mount to the top of the shoe by extending beyond the shoe tongue within the shoe.

9. The front-leg assistive exoskeleton of claim 1, wherein the foot mount comprises an attachment pin joint for attaching the connector.

10. The front-leg assistive exoskeleton of claim 9, wherein the attachment pin joint enables a rotation about an ankle joint without fully constraining a perpendicular rotational degree of freedom about the ankle joint.

11. A method for augmenting a human gait using a front-leg assistive exoskeleton comprising:
securing a shin mount to a shin of a person such that the shin mount is enabled to push and pull on the shin in a normal direction. wherein the shin mount comprises a material;
attaching a foot mount to a top of a shoe;
connecting, via a connector, the shin mount to the foot mount, wherein the connector houses an actuator; and
actuating the actuator to apply a force that generates torque about an ankle that modifies the human gait of the person.

12. The method of claim 11, wherein the material wraps around the shin to secure the shin mount to a leg of the person.

13. The method of claim 11, further comprising:
attaching electronic components for the exoskeleton to the shin mount via an attachment mechanism.

14. The method of claim 11, further comprising:
dynamically changing a distance between the shin mount and the foot mount using telescoping tubes of the connector.

15. The method of claim 11, further comprising:
changing, via a spring of the connector, a force profile of the actuator;
storing, via the spring, a potential energy triggered by the actuator; and
converting the potential energy to a kinetic force via a motion of the leg or foot.

16. The method of claim 11, further comprising:
attaching the foot mount to the top of the shoe via an attachment piece inserted at a base of the shoe tongue.

17. The method of claim 11, wherein:
the foot mount carries an inertial measurement unit (IMU);
the IMU measures a relative angle between the foot and the shin;
the relative angle determines a gait state of the person;
the gait state determines the forces that generates the torque.

18. The method of claim 11, further comprising:
securing the foot mount to the top of the shoe using two tabs that extend beyond the shoe tongue within the shoe.

19. The method of claim 11, wherein the foot mount comprises an attachment pin joint for attaching the connector.

20. The method of claim 19, wherein the attachment pin joint enables a rotation about an ankle joint without fully constraining a perpendicular rotational degree of freedom about the ankle joint.
